(19) United States
(12) Patent Application Publication
(10) Pub. No.: US 2017/0316709 A1
(43) Pub. Date: Nov. 2, 2017

(54) Method for Personalized Learning Using a Seamless Knowledge Spectrum

(71) Applicant: MiddleScholars, Inc., San Jose, CA (US)

(72) Inventors: Shoukat Ali, San Jose, CA (US); Anjum Anwar, San Jose, CA (US)

(73) Assignee: MiddleScholars, Inc., San Jose, CA (US)

(21) Appl. No.: 15/144,445

(22) Filed: May 2, 2016

(51) Int. Cl. G09B 7/04; G09B 5/12

(52) U.S. Cl. CPC G09B 7/04; G09B 5/125

(57) ABSTRACT

The software system gives students the teacher homework question. The system also asks the students to write a more difficult question than teacher question and a less difficult question to be linked with original. The system uses machine learning techniques to rank the questions. The software system then asks students who are part of the class to rank these unordered questions. The system re-ranks the question list and repeats the process all the questions are ranked. The system uses these ranked lists to personalize learning of students. The system first presents the student with a teacher question from the list used by the majority of the students. Then the system provides synonym questions and midway questions to determine student's current knowledge. The system then seemlessly increases the student knowledge by presenting questions which are increasingly difficult.

There is a lot of work going on in the field of customized learning, with the goal of presenting each student with personalized learning content that the student can pursue any time, any place, any pace. Unlike the efforts where a learning customizer analyzes student grades in a given set of questions to be able to customize learning, the focus here is to create learning content that can be seamlessly customized.

The purpose of this invention is to create a knowledge spectrum, and to enable creation of algorithms to locate and move a student in that space. By doing so, this invention offers a ‘seamless’ learning experience to a student. The student would have none of the limits induced by ‘seams’ of any kind.

### BRIEF DESCRIPTION OF THE DRAWINGS

FIG. 1 depicts what a teacher might see as the learning spectrum for a student on a 4-point discrete spectrum.

FIG. 2 depicts a worst case scenario for the learning spectrum for a student in which the student has a learning problem at the beginning stages of the learning spectrum.

FIG. 3 depicts another worst case scenario for the learning spectrum for a student in which the student has a learning problem at the ending stages of the learning spectrum.

FIG. 4 depicts five synonyms at knowl k1—k1, k3, k4, k5 and k6.

### THE PROBLEMS SOLVED BY INVENTION

What really stops students from understanding something is the gap between what they know and what they are being asked to learn. So how do we bridge the knowledge gap between what a student knows (call it K) and what they are being asked to learn (call it L)? One can imagine a number of knowledge increments (call it a path) that can lead a student from K to L. However, there is no single path from K to L that is likely to work for every student. We could start by first bridging the gap G between K and the midpoint between K and L. If the student does not know the midpoint, i.e., K+G/2, then we further bisect the gap from K to K+G/2.

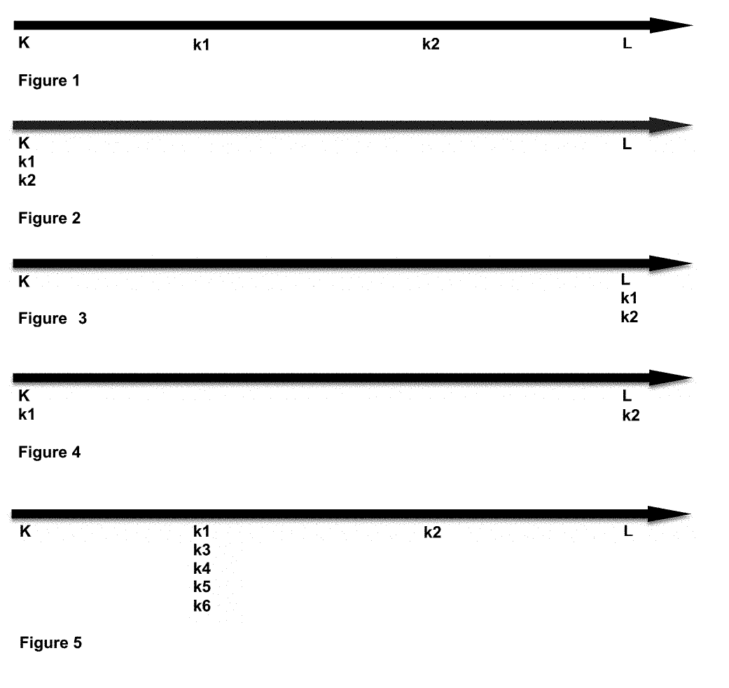

The key assumption in the above approach is that the midpoint G/2 is known and the knowledge is ordered. However, to know the midpoint, one has to actually know the entire spectrum from K to L. A given teacher may not be able to determine the midpoint with a good enough accuracy because his view of the learning steps from K to L may not actually have a ‘stop’ at the midpoint. For example, a teacher may believe that K to L is a discrete space with 2 stops, i.e., his spectrum is the following 4-point discrete spectrum: K, k1, k2, L (as shown in FIG. 1). Please note that we cannot assume that the four points are evenly separated (which is really the best case, as far as the student's chances of learning are concerned). As for the worst case, there are three worst cases: (a) K=k1=k2, (b) K=k1 and k2=L, and (c) k1=k2=L. In case (a) shown in FIG. 2, the teacher is repeating what the student already knows, and in (c) shown in FIG. 3 he is repeating what the student already does not know. In (b) shown in FIG. 4, the teacher is doing a mix of cases (a) and (c). The authors have seen both of these worst cases in their careers. Let us advance our formulation by assuming that the teacher's selection for the midpoint G/2 is k1. In his view, if the student cannot learn k1, then there is nothing more that the teacher can do.

However, while a given teacher may not have a fine enough spectrum from K to L, other teachers may. Actually, if this spectrum building is simultaneously worked upon by a number of teachers with diverse backgrounds, the spectrum may soon get a high resolution. Therefore, the key assumption used in the above paragraph could possibly be met if we assume there is a large enough and diverse enough pool of teachers trying to determine G/2.

The central contribution of this new learning mechanism is a process for the creation of a continuous knowledge spectrum (CKS) that could offer a student a ‘seamless’ learning experience. The student would have none of the limits induced by ‘seams’ of any kind (however, the inclination of the student may be a factor, a legitimate factor).

### Middle Schooling

For a better exposition of this work, we denote by knowl a point on the CKS. We denote as the midway knowl the point on the spectrum that is exactly the middle point of two knowls a and b. Further assume that a and b are connected by a directed edge a->b, where b represents a more advanced state of knowledge. And for ease of expression, we will refer to the CKS as just ‘the spectrum’. The search for the midway knowl is what leads us to naming this approach the middle schooling. The goal of the middle schooling is construction of a high resolution spectrum given two points in a particular learning space, e.g., physics. Theoretically speaking the goal would be to build a continuous spectrum from K to L. In its full glory, the goal would be to build every spectrum from K to L, where each such spectrum would be continuous. We are using the word ‘spectrum’ to emphasize that there is a continuum and a seamlessness in the progression of knowledge.

### Knowl Score

Every person viewing a given knowl is free to evaluate it. Specifically, the evaluator is asked to determine if the knowl is too similar to the knowl on its left, or if it was probably in the middle, or if it is too similar to the knowl on its right. Given enough evaluators, the system assigns the knowl a 3-element goodness score, <left, middle, right>. Say that a particular knowl had a score of <s1, s2, s3>. This means that of all the people who evaluated this knowl s1% evaluators believed that it was too similar to the knowl on its left, s2% believed that it was probably in the middle, and s3% believed that it was too similar to the knowl on its right. A knowl with a high middle score is the one that is more likely to help a student make a seamless transition from the left to the right. The knowl score is the value of the middle element of the goodness score.

The scholars's task is to repeatedly bisect a knowledge space until it reaches an ‘atomic state’. That is, it is not possible to bisect the space between two given knowls.

### Knowl Synonyms

A knowl may have synonyms where a synonym does not add to the knowledge but re-expresses in a way that a person from a different social background or native language or learning style can relate to it. One example can be taken from computer architecture. Assume there is a knowl that explains the difference between CISC and RISC computers, and gives an analogy of Applebee's versus In-N-Out, where the menu at Applebee's is like the instruction set of a CISC computer, and the menu at In-N-Out is like the instruction set of a RISC computer. For a student who does not know about these restaurants, the analogy would either have to be dropped or replaced with another one that may be relatable by the student. Such a rephrasing would be called a synonym of the original phrasing. As another example, if the reader has no computer architecture background, then the entire above paragraph would have to be replaced with another version that does not talk about computer architecture, or at least not CISC and RISC.

While the above example focused on social background, there are obviously differences in learning style that can also be addressed with multiple synonyms. For example, a picture is worth a thousand words, but not to every student. Some students would rather see some words instead of a picture. For this reason, each knowl in the spectrum should have at least as many synonyms as the types of learning modes (examples first, general principle first, picture first, words first, etc.).

Each synonym is associated with a utilization score, which is the percentage of times that synonym was chosen over other alternatives.

FIG. 5 shows five synonyms at knowl k1. These are k1, k3, k4, k5 and k6.

### Spectrum Depth

The possibility of presence of knowl synonyms means that our continuous knowledge spectrum may also be multilayered. The depth of the spectrum at knowl k is defined as the number of synonyms available at k. It is not necessary or likely that the depth of the spectrum at every knowl would be the same. Therefore the depth of the spectrum is defined as the smallest depth over all knowls. The knowl that has the smallest depth is called the knowl of least understanding (KOLU). If a KOLU is not deep enough, then it becomes a point where the students may leave the learning process. One goal for building or improving the spectrum is maximizing the spectrum depth or the depth of the KOLU. Imagine people from different national, cultural, religious and economic backgrounds trying to deepen one knowl while making sure they do not add ‘displace’ the knowl, i.e., they do not add to or remove from the knowledge content of the knowl.

### Middle Scholars

The Middle School does not replace teachers. It actually relies on them even more than the current school. Specifically it adds a new role to a teachers' job; the role of a Middle Scholar. The Middle Scholars will be a new breed of scholars who will come from the current textbook authors, K-12 teachers, college professors, students, researchers, parents running home schools, and anyone with a passion for teaching. The Middle Scholars will take material from their books and their minds and add it as knowls or knowl synonyms on the spectrum. Their goal would be to place as many Midway Knowls and their synonyms as possible. From what we know about some of the best teachers we have seen, we know that they love breaking a problem down. The Middle School gives them a framework where they can break down the problems, and in doing so create a knowledge spectrum that students from anywhere can ride to success.

1. A computer implemented method for ranking knowledge system for personalized learning on at least one computer processor comprising said steps of:
receiving a question response to teacher's question from group of student;
receiving a more difficult question and a less difficult question from students in comparison to teacher question;
ranking teacher question and student questions via computer ranking algorithm;
receiving ranking of unranked questions from students within ranked questions; and
re-ranking of student ranked questions via computer ranking algorithm.

2. The computer implemented method of claim 1 wherein automated computer based ranking process uses a word matching mechanism.

3. The computer implemented method of claim 1 further comprising said steps of:
capturing multiple parallel lists from said question list.

4. The computer implemented method of claim 3 further comprising said steps of:
providing synonym question to said student via software GUI because student is unable to answer question;

5. The computer implemented method of claim 3 further comprising said steps of:
providing more difficult midway question for said student via software GUI because student question is too easy;

6. A computer implemented method of personalized learning on at least one computer processor comprising said steps of:
providing a teacher's question to student via software GUI;
providing easier midway question to said teacher's question via software GUI for said student because student is unable to answer question;
providing easier midway question to midway question via software GUI for said student because student is unable to answer question;
receiving correct student answer to said midway question;

7. The computer implemented method of claim 6 further comprising said steps of:
providing more difficult midway question via software GUI because student answered easier midway question.

8. The computer implemented method of claim 6 further comprising said steps of:
providing original question to said student via UI when said last correctly answered question has smaller difficulty than the preconfigured difficulty threshold.

9. The computer implemented method of claim 6 wherein easier midway question has half of the difficulty as the question said student is unable to answer.

10. The computer implemented method of claim 6 wherein more difficult midway question has difficulty which is the midpoint of the question said student is unable to answer and question that student is able to answer.

11. The computer implemented method of claim 6 wherein the personalized learning runs on a mobile computing device.

12. The computer-implemented method of claim 6 wherein the personalized learning runs on a web browser.
